(19) United States
(12) Patent Application Publication
(10) Pub. No.: US 2024/0369100 A1
(43) Pub. Date: Nov. 7, 2024

(54) SOUND-ABSORBING ENCLOSURE (H) AND METHOD FOR PRODUCING A SOUND-ABSORBING ENCLOSURE (H)

(71) Applicant: Schaeffler Technologies AG & Co. KG, Herzogenaurach (DE)

(72) Inventors: Alfred Pecher, Schweinfurt (DE); Thomas Fiebig, Wiesentheid (DE); Carsten Merklein, Nürnberg (DE)

(73) Assignee: Schaeffler Technologies AG & Co. KG, Herzogenaurach (DE)

(21) Appl. No.: 18/689,603

(22) PCT Filed: Aug. 18, 2022
(86) PCT No.: PCT/DE2022/100614

§ 371 Date: Mar. 6, 2024

(30) Foreign Application Priority Data
Sep. 14, 2021 (DE) 10 2021 123 665.7

(51) Int. Cl. F16C 19/52; B33Y 80/00; F16C 33/64; G10K 11/162

(52) U.S. Cl. CPC F16C 19/527; B33Y 80/00; F16C 33/64; G10K 11/162

(57) ABSTRACT

A method for producing a sound-absorbing enclosure for a sound emission source which emits sound having an energy spectrum includes constructing an irregular structure from substructures is printed from a printing material by means of 3D printing. The structure has material regions which are formed by the printing material and which at least partly enclose hollow regions, and, by virtue of the hollow regions, the substructures each have a characteristic length lying within a characteristic interval and a characteristic density. The hollow regions are specifically formed by appropriate guidance of the 3D printing process and thereby the substructures with these features are adapted to the energy spectrum in such a way that they dissipate sound in a desired suppression range of the energy spectrum. A printed, sound-absorbing enclosure for a sound emission source is also disclosed.

### CROSS-REFERENCE TO RELATED APPLICATIONS

This application is the United States National Phase of PCT Appln. No. PCT/DE2022/100614 filed Aug. 18, 2022, which claims priority to German Application No. DE102021123665.7 filed Sep. 14, 2021, the entire disclosures of which are incorporated by reference herein.

### TECHNICAL FIELD

The present disclosure relates to a sound-absorbing or sound-dissipating enclosure which at least partly encloses a sound emission source in such a way that the emitted sound is attenuated in a desired frequency range and desired amplitude. The disclosure further relates to a method for producing such an enclosure.

### BACKGROUND

The absorption of sound (S), be it in the form of airborne sound that spreads in the air or water or other liquids and can be perceived by the human ear, or be it in the form of structure-borne sound as vibrations propagating in solid bodies has long been an important requirement for the design of machines, devices, components or buildings. As with pollutant emissions, the requirements for reducing noise emissions are becoming more stringent over time, be it due to legal requirements, the perception and needs of a consumer or user, or technical specifications and requirements in vibration-capable systems. Transition from the internal combustion engine to electric drives, for example, means that the lower noise emissions of the electric drive also bring components into acoustic perception that were previously negligible in terms of their noise emissions compared to those of the drive. The resulting gradual reduction in noise emissions continues this sensitization effect in a cascading manner and thus increases the need for improved noise protection measures. In addition to the pure absorption of sound, which usually only means the conversion of the mechanical kinetic energy of a sound wave into thermal energy, the term absorption in the following also includes the dissipation of sound waves, i.e. at least partly a statistical scattering of the sound signal in such a way that it is essentially converted into noise.

In addition to avoiding sound emissions, for example by avoiding and reducing the generation of vibrations, it is often necessary to reduce sound emissions by means of absorption. Sound is dissipated in a medium in such a way that the sound energy is converted into thermal energy.

A multitude of different approaches and solutions for designing structures and materials for sound absorption are known, for example: U.S. Pat. No. 7,743,880B2 discloses a sound-absorbing structure, the design of which is particularly suitable for absorbing low-frequency sound, wherein the structure can be designed compactly. U.S. Pat. No. 9,033,101B2 describes a sound-absorbing material that is constructed of a two-component fiber material.

The “3D printing” manufacturing process, or also known as “additive manufacturing” in English, is a process that has developed very dynamically in recent years with an ever-increasing number of uses. A material is brought into almost any shape by pixel-like printing, for example by melting tiny droplets from a nozzle or the like. However, applications in the area of acoustics have not been the focus so far. In the article “Study of the Sound Absorption Properties of 3D-Printed Open-Porous ABS Material Structures”, Polymers (Basel), May 2020, 12(5): 1062 (online publication), the sound-absorbing properties of plastic elements made of a special plastic produced using 3D printing are investigated. In the article “Chaotic Printing: using chaos to fabricate densely packed micro- and nanostructures at high resolution and speed”, Materials Horizon, Vol. 5, No. 5, September 2018, pp. 755-1010, the dynamic material flow of the material to be printed creates a turbulent flow during the printing process, which creates chaotic structures in the printed material. Acoustic properties are not examined here.

US 2021/0138726 A1 describes a 3D printing process for producing a silicone foam, in which a porous structure is created by adding micro salt balls to the printing process.

US 2020/0109300 A1 discloses a method for producing a regular structure of a porous elastomer foam using 3D printing in order to avoid the disadvantages of irregular, stochastic structures, in particular their long-term stability. Gas-filled micro-balloons are incorporated into the structure.

### SUMMARY

The present disclosure provides a sound-absorbing enclosure which is well adapted to an individual sound emission source. The disclosure also specifies a production process for such an enclosure.

The disclosure provides a method for producing a sound-absorbing enclosure for a sound emission source which emits sound having an energy spectrum, wherein an irregular structure constructed from substructures is printed from a printing material by means of 3D printing. The structure has material regions which are formed by the printing material and which at least partly enclose hollow regions, and the substructures each have a characteristic length lying within a characteristic interval and each have a characteristic density of hollow regions. The substructures with these features are adapted to the frequency spectrum in such a way that they dissipate sound in a desired suppression range of the energy spectrum.

The disclosure therefore proposes to produce a sound-absorbing enclosure having an irregular structure by means of a 3D printing process. Despite the well-known advantages of 3D printing, this process initially appears to be unnecessarily complex and complicated when used to create a sound-absorbing enclosure. After all, a soundproofing material would usually simply have to be attached or applied more or less only around the sound source, for example by simply wrapping it, plastic injection molding or as a solid housing or the like. It seems complex to design this structure irregularly, since 3D printing is subject to a determinate process, so the irregularity must be specifically adjusted, unlike statistical methods such as admixtures.

However, the disclosure is based on the knowledge that a targeted, sound-absorbing, irregular structure can be produced using 3D printing, even if the templates for 3D printing have so far been created almost exclusively using suitable CAD processes or typical construction. While conventionally, either homogeneous, sound-absorbing materials are used in macroscopic dimensions and those of typical sound wavelengths, or regular, lattice or lattice-like structures are used to absorb vibrations and then dampen them with internal friction, the disclosure takes a completely different path: An irregular structure is created from substructures, so that there is a statistical distribution of reflection surfaces and surfaces that are significant for sound propagation, which lead to an approximately maximum dissipation of sound propagation.

The term “irregular” is therefore to be understood to mean that no grid-like unit cell of the spatial structure can be defined or that there is no essentially homogeneous distribution. This observation is carried out with a macroscopic, at best mesoscopic resolution, which plays a role in comparison to the wavelengths of the relevant sound. Significantly above this scale, the structure would appear homogeneous, significantly below, the structure would exhibit microscopic, possibly regular lattice structures, depending on the material used.

Cavities are spaces that are filled with a gaseous, liquid or solid material that differs significantly from the printing material in its ability to conduct sound and is also softer. Typically the cavities will be filled with air or liquid. In principle, any materials that can be processed using 3D printing can be used for the printing material, but materials that already have sound absorption in the desired range as an intrinsic property are preferred.

The term enclosure is not to be understood as restrictive in that the sound emission source must be completely or even predominantly surrounded by the enclosure. An enclosure in the present sense would also mean partial shielding of the emitted sound, for example a flat element which at least partly absorbs sound from the sound emission source in a certain solid angle. In this sense, the term enclosure also means a lining element that reduces sound propagation in a specific direction.

The cavities now characterize the substructures: A substructure is defined by a class of cavities whose characteristic expansion, e.g. a spherical diameter in the case of a spherical shape of the hollow regions, lies within a specific, predefined interval. A density is then specified for this substructure, i.e. the frequency with which cavities of this type occur in the structure, possibly weighted with the cavity size. Due to its characteristic expansion class, each substructure will have a sound-scattering effect, particularly in those frequency ranges whose wavelengths lie in the range of this expansion class. It is now possible to adapt the sound-absorbing enclosure to the energy spectrum of the sound emission source by selecting suitable substructures with regard to the expansion classes or expansion intervals used and the frequency of their occurrence, i.e. their density. With knowledge of the energy spectrum, 3D printing makes it possible to achieve individualized sound absorption.

The structure may be calculated by an algorithm. In principle, 3D printing could also be based on an empirically obtained distribution of cavities. However, adapting the printing pattern to a specific application, i.e. generating a new distribution of substructures, possibly with a new size classification and assigned densities, can be achieved efficiently using an algorithm. The algorithm may be random-based, i.e. the structure is generated from a random distribution of the substructures with their predetermined characteristics. A geometry of the enclosure may be predetermined and a substructure of a hollow region may be generated by a random position of a center point and a diameter of a hollow region, wherein the number of hollow regions of the substructure is selected in accordance with a desired density of this substructure. “Center point” and “diameter” can be precise values for geometrically simple shapes of the hollow regions, e.g. spherical or tetrahedral, but they can also be approximately determined if the selected hollow region shapes are irregular or highly asymmetrical.

For example, the enclosure could have the shape of a cylindrical jacket in which, for example, spherical cavities of different size classes and different densities are present A random algorithm then specifies a center point as a vector for a cavity of a certain class within the enclosure, as well as a spherical radius that corresponds to the characteristic radius of the class, either exactly to this radius or chosen from a statistical distribution around the radius. For this class of cavities, this is carried out as often as corresponds to the desired density of the class. All other cavity classes are treated accordingly, so that the desired structure is ultimately formed from the substructures of the cavity classes.

An algorithm also includes a procedure that defines a structure in the sense of a trial and error procedure. If a sound emission spectrum is specified spatially and in terms of frequency and amplitude distribution, the algorithm could consist of first deriving base points from the frequency spectrum that underlie a substructure, i.e., deriving the corresponding wavelength with a specific interval from the frequency and defining a characteristic length of a substructure from this. The spectrum would be discretized accordingly with further substructures. In frequency ranges with higher amplitude, these base points would be placed closer together and the intervals around them would become narrower. In addition, the density of the respective substructure would be selected relative to the densities of the other substructures in accordance with the respective average amplitude in the wavelength interval of the substructure.

With such a starting configuration, derived directly from the sound emission spectrum, absorption capacity could now be tested using a simulation. By then varying the parameters of the subgroups, local maxima for the absorption and thus an at least locally optimal structure (in the parameter space) can be determined. In the sense of an overall process, this could be carried out in such a way that a sound-insulating enclosure is calculated directly and, if necessary, printed out immediately by simply entering the sound emission spectrum, with its spatial characteristics and an overall geometry of the enclosure.

The hollow regions may be designed to overlap and are therefore open to one another in such a way that they form a continuous channel through which a cooling liquid or a cooling gas can be guided. Some hollow regions therefore form a continuous channel through the enclosure by overlapping adjacent hollow regions. In principle, this channel formation can be incorporated “manually” into the print template. However, this effort can be avoided by forming a continuous channel with statistically sufficient probability in a desired region such that the density of cavities whose dimensions are suitable for channel formation is above a percolation threshold. The phenomenon of percolation is the formation of a continuous connection, from one edge to another, of statistically distributed elements within the edges. During percolation concentration, a “geometric phase transition” occurs from mutually isolated outer edges to interconnected outer edges of the enclosure. In addition to the density of the cavities, their shape and orientation must also be taken into account. If the percolation concentration is known, cooling channels can be statistically adjusted at desired locations by choosing the cavity geometry and density.

The simultaneous requirement for cooling and sound insulation is quite common in technical applications. Friction, in particular, can be a common cause of vibrations and heat. However, this can lead to a collision of requirements: Good sound insulation is usually based on materials that mesoscopically or microscopically have a variety of interfaces with regard to sound conductivity, e.g. porous or fiber materials. However, such materials often reduce thermal conductivity at the same time, meaning sound insulation goes hand in hand with thermal insulation. By designing the sound insulation with integrated cooling channels, this can be counteracted in the proposed manner without having to provide straight channels that could again represent sound conductors. The percolation of cavities thus represents the creation of cooling channels, which cooling channels are created without any additional design effort, so to speak, while retaining the good sound-insulating properties. Initially, all liquids and gases can be used as coolants, whereby the viscosity, for example, must be matched to the dimensions of the hollow regions in order to enable sufficiently low flow resistance.

The cavities of a substructure may be arranged offset from one another at an incommensurable ratio in a radial direction as seen from the sound emission source along a circumferential direction with respect to the radial direction. This can also be described in such a way that there are layers of cavities around the sound source in a radial direction. If only cavities of one class are considered, the distances in the circumferential direction at which a cavity is offset from that of a neighboring layer should be as far away as possible from an integer ratio, i.e. a rational number. If these distances are ratios of small integers, interference effects can occur during sound scattering, i.e. the sound is not dissipated isotropically.

A rational ratio leads to the formation of a regular superstructure in the radial direction: the arrangement of the hollow regions repeats itself in the rational ratio from a certain radial layer onwards. A distance ratio that corresponds to a rational number formed from the largest possible integers (approximates an irrational number) avoids this regularity up to a radial expansion that lies above the thickness of the enclosure. This prevents the formation of a radial superstructure within the enclosure. The successive layers are then arranged incommensurably. This arrangement of petals is familiar from multi-row wreath flowers: The leaves are arranged around the circumference in such a way that they overlap as little as possible with the other rows for better light yield. Such an arrangement can be easily realized with an algorithm, for example by using a distance calculated from a highly irrational number, e.g., the golden ratio.

At least some of the hollow regions may be designed in a geometric shape, whose orientation and dimensions result in the highest possible sound dissipation according to the spatial expansion of the sound emitted by the sound emission source. While a spherical shape is the simplest cavity shape, other shapes can achieve better absorption properties. In particular, a half-screw shape can be considered. This is designed such that an opening of the half-screw shape is oriented towards the sound emission source and the screw flight converges in the direction of sound propagation. Anisotropic sound distributions in particular can also be taken into account through the geometric selection of the basic cavity shapes.

The present disclosure also provides a printed, sound-absorbing enclosure for a sound emission source which emits sound having an energy spectrum, which has an irregular structure constructed of substructures. The substructures each have a characteristic length scale and density and the substructures are adapted to the frequency spectrum in such a way that they dissipate sound in a desired suppression range of the energy spectrum.

The composition of the structure of the substructures may change along an extension of the enclosure in such a way that the sound dissipating characteristics of the structure are adapted to an anisotropic emission of the sound emission source. The composition of the structure therefore changes on a macroscopic scale. This takes into account the anisotropy of the sound emission, which can have different amplitudes and frequency ranges depending on the direction of radiation. Using the individualized 3D printing process, a structure can now be adapted to a specific sound emission spectrum, and not just in terms of its mesoscopic structure; it can also be designed differently depending on direction and position.

The enclosure may be printed on a housing at least partly enclosing the sound emission source.

The enclosure may form a housing at least partly enclosing the sound emission source. With the 3D printing process, a housing is printed at the same time as the enclosure, such that the enclosure takes on another property in addition to its sound absorption property.

The sound emission source may be positively connected to a connecting component, and the positive connection is formed by a damping element produced using a 3D printing process in such a way that a structure-borne sound conduction from the sound emission source to the connecting component is weakened in a predetermined frequency range.

The enclosure may be part of a bearing, e.g., a roller bearing, having an inner and an outer ring, and the enclosure surrounds the outer ring or the outer ring itself is formed by 3D printing and forms the enclosure surrounding the sound emission source.

### BRIEF DESCRIPTION OF THE DRAWINGS

The disclosure is explained in more detail with reference to the drawing. In the figures:

FIG. 1 shows the section of a sound-insulating enclosure with a structure formed from substructures;

FIG. 2 shows the section from FIG. 1, in which the density of a substructure is so great that a cooling channel is formed;

FIG. 3a shows a starting point for the calculation of an irregular structure;

FIG. 3b shows the irregular structure formed from the starting point of FIG. 3a;

FIG. 3c shows a further step after the starting point of FIG. 3a;

FIG. 3d shows the formation of an irregular connection between points of FIG. 3a;

FIG. 4 shows a structure formed by an incommensurable dislocation of hollow regions;

FIG. 5 shows examples of geometric shapes of hollow regions;

FIG. 6 shows a sound-insulating enclosure around an anisotropically radiating sound emission source; and

FIG. 7 shows a component with a sound-insulating enclosure that is in contact with a further component.

### DETAILED DESCRIPTION

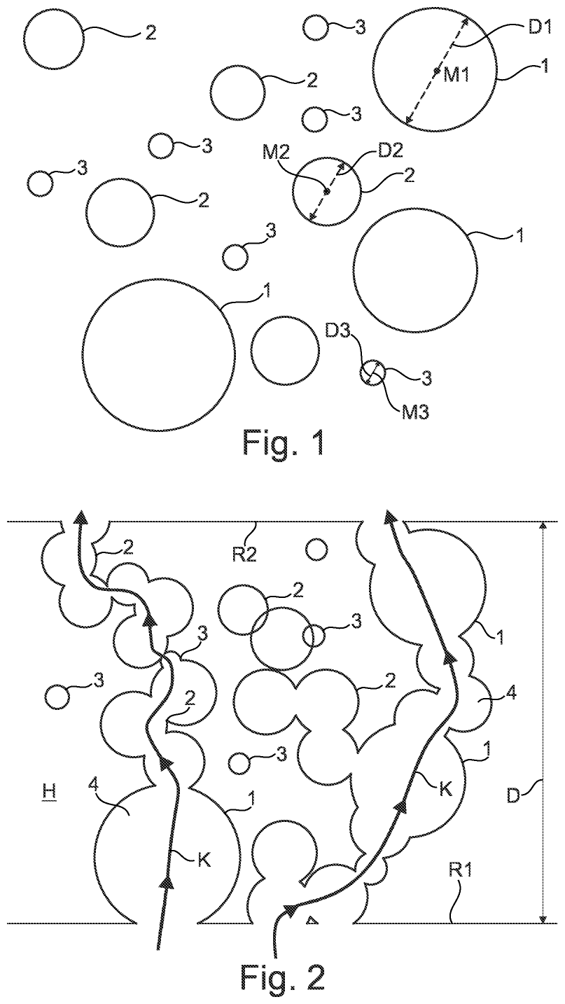

FIG. 1 shows a section of a sound-insulating enclosure H, which is produced using a 3D printing process. In this example, the enclosure H has a structure that is formed from three substructures 1,2,3. These are cavities which are enclosed by the printed material. When the print is built up in layers, these cavities are left out of the printing material. The printing material itself can already have sound-insulating properties. The hollow regions 1,2,3 create boundary surfaces of sound resistance that lead to reflections. If such reflections are now formed in a suitably irregular manner, sound is sufficiently dissipated. In the present case, the hollow regions 1, 2, 3 would serve as scattering surfaces for structure-borne noise, which propagates through the printed material. However, a reverse configuration is also conceivable, in which airborne-sound propagates through interconnected cavities and is scattered and dissipated at the irregular boundary surfaces. This is shown below using FIG. 2.

The substructures differ in their diameters D1, D2, D3, which are precisely defined in the present case, as spherical hollow regions 1,2,3 are formed. The diameters D1, D2, D3 are the characteristic lengths of the substructures. For other, geometrically less exact shapes, other values could be considered as characteristic lengths, e.g. averaged expansion values or maximum or minimum expansions. The characteristic lengths are suitably classified in order to subject them to a simple algorithm for distribution, by means of which the sound absorption can be adapted particularly well to a sound emission spectrum. In this case, three intervals are specified according to which the substructures are grouped according to their diameters: A class 1 with a large characteristic length D1, a class 2 with a medium characteristic length D2, and a class 3 with a small characteristic length D3. Class 1 is therefore more suitable for dissipating longer wavelengths, class 3 for shorter wavelengths.

By specifying the number of hollow regions 1,2,3 and thus their density in the enclosure, absorption can be adapted to the energy spectrum. If, for example, the energy density of the sound emission source E is greater in the high-frequency range, the density of class 3 is selected higher. Of course, the number of classes can also be freely selected, so the intervals for classification can also be very accurate and almost continuous. The position of the hollow regions 1, 2, 3 can be determined by randomly selecting their centers M1, M2, M3. These center points M1, M2, M3 can be defined as vectors in a vector space region, which corresponds to the overall geometry of the enclosure H. In this permitted range, the hollow regions 1,2,3 are then created in accordance with the specified densities by randomly selecting the center point and, if necessary, also by randomly selecting the diameter of the hollow region within the specified interval of the hollow region class.

FIG. 2 shows a structure corresponding to FIG. 1. Here, however, the density of the hollow regions 2 of class 2 is so high that hollow regions 1, 2, 3 overlap and thus connect. The density is also higher than a percolation concentration. The effect of percolation results in a geometric phase transition, which initially connects separate edges of an area with a closed path by increasing overlap with increasing concentration. For example, you could throw floating planks into a pond until you connect one bank to another with a continuous path on the planks. In the present case, two channels 4 are formed between a first edge R1 of the enclosure and a second edge R2 of the enclosure, which has a thickness D. Such channels can be used to conduct airborne sound (“air” can of course stand for any gas here), which is attenuated by reflection from the irregular boundaries. Of course, the channels do not have to be continuous, but simply provide a sufficient path for the airborne sound. The attenuation of structure-borne sound as described in FIG. 1 and the attenuation of airborne sound by means of connected cavities can of course also be utilized in combination.

A cooling medium K can also be guided through such channels, which actually extend continuously through the enclosure H. For example, the printing of the enclosure H can be designed in such a way that the percolation concentration for the hollow regions 1, 2, 3 is reached or exceeded specifically in regions subject to particular thermal stress, so that continuous channels are created here through which the cooling medium can be guided. If necessary, a changed sound characteristic due to a different sound velocity and sound attenuation in the cooling medium K is taken into account for the design of the enclosure H. With this integrated cooling system, it is now also possible to take account of divergent requirements that arise from the fact that effective sound insulation often also entails thermal insulation, which can stand in the way of necessary heat dissipation.

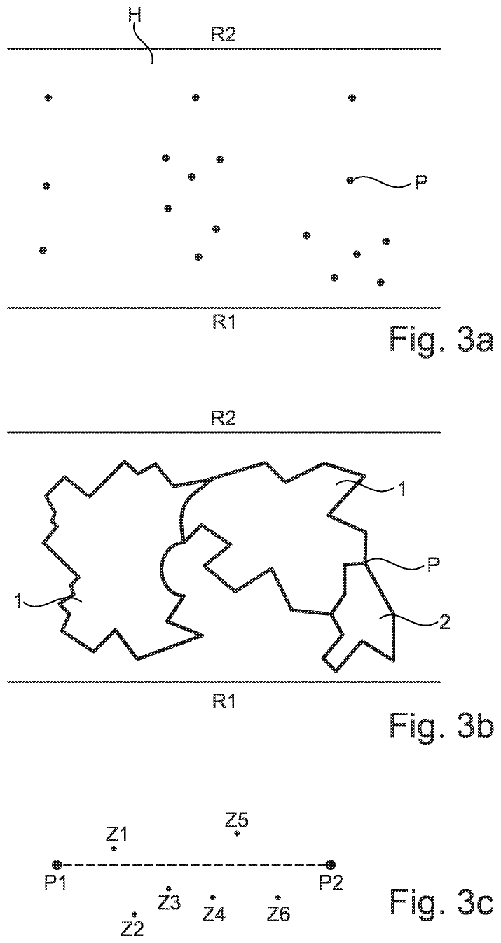

FIGS. 3a-3d show another possibility of building an irregular structure. In FIG. 3a, points P are selected within the geometry of the enclosure H. These can be points of a regular grid or several regular grids lying one inside the other. However, if these points P are connected using a random algorithm, the result is an irregular structure as shown in FIG. 3b. The point connections are therefore the printed walls, which in turn enclose hollow regions 1,2,3. FIG. 3c shows how such a “random connection” can be generated: A number of points, in this case six, Z1-Z6, are randomly scattered around the dotted line connecting two points P1, P2 at a specified distance in the direction of the connection. These points Z1-Z6 are then connected in a straight line, resulting in a random “zig-zag” line that defines a hollow region wall.

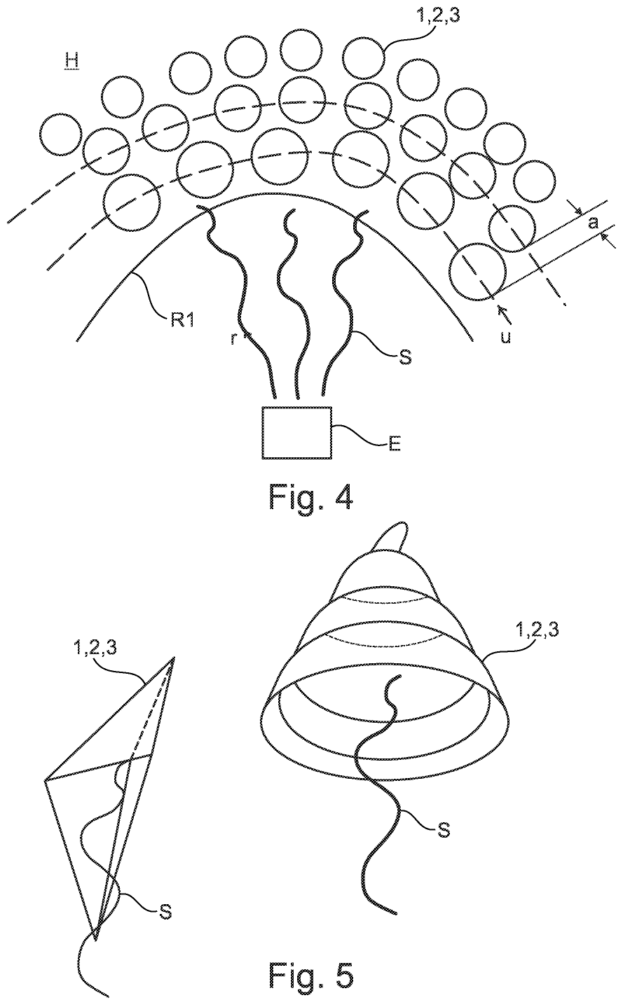

FIG. 4 shows another possibility in which an irregular structure can be constructed from hollow regions 1, 2, 3. The sound emission source E radiates sound S in a radial direction r. Along a circumferential direction u in relation to the radial direction r, hollow regions 1, 2, 3 are arranged at fixed intervals, i.e. at regular intervals. However, the hollow regions in radially successive layers are offset by a value a such that an incommensurable, irregular arrangement results in the radial direction. The value a is therefore not a small integer part of the circumferential distance, because this would result in the arrangement of the hollow regions again corresponding to that of the first layer after a few radial layers. This would result in a regular superstructure, which can lead to sound interference and thus reduced dissipation. The value a is therefore selected as the ratio of two sufficiently large integers without divisors in such a way that there is no repetition of the position of the hollow regions 1, 2, 3 in the circumferential direction within the thickness D, i.e. the radial extension. The value a is therefore chosen to be “sufficiently irrational”.

FIG. 5 shows examples of shapes of hollow regions 1,2,3 which, unlike the spherical shape, have anisotropic properties and can therefore be used to adapt to a sound emission spectrum not only in terms of their expansion and density but also through their orientation. The tetrahedron shape shown has surfaces that could possibly be used for targeted sound deflection, while the half-screw shape shown may be open towards the sound emission source E and converge in the direction of propagation, which results in favorable dissipation.

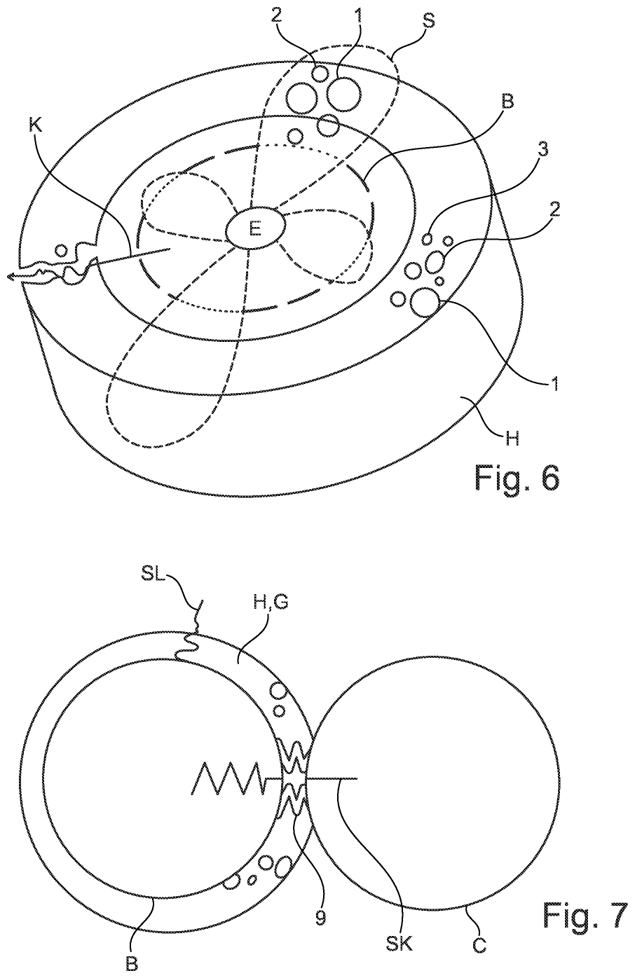

FIG. 6 shows an enclosure H which is applied to a component B, e.g. a roller bearing. It could, for example, be printed directly onto a housing G of component B or form a housing G itself. In particular, the enclosure H can also be an inner or outer ring of the roller bearing, in which case it directly forms a raceway for rolling bodies and directly dissipates the sound caused by the rolling bodies running off it. The sound emission source caused by component B radiates anisotropically in amplitude and frequency. Accordingly, the cavity density of class 1 cavities is greater in an area that has a higher energy density of low-frequency radiation than in an area where a greater proportion of high-frequency radiation occurs and therefore more class 3 cavity areas are selected. In another area, which is subject to a higher thermal load, the cavity density is selected above the percolation threshold so that a cooling medium K can be fed through the enclosure H through the cooling channel 4 that is formed.

FIG. 7 shows a configuration where a component B, which carries the enclosure H, is in contact with a neighboring component C. Such a contact can represent a bridge for structure-borne sound SK, which emanates from component B in addition to the airborne sound SL. In order to reduce such sound conduction to the neighboring component C, it is now possible to print a damping element 9 using 3D printing. The shape, size and orientation of this can in turn be optimally adapted to the structure-borne sound and it may be integrated directly into the enclosure H. However, the damping element can also be designed in terms of rigidity and strength to meet the requirements resulting from the contact between component B and C at the same time. Component B can be a roller bearing. It is also conceivable here that the enclosure H can be an integral part of the roller bearing B, so that it is not printed on the outer ring, for example, but forms an outer ring of the roller bearing B directly, on which rolling bodies run.

### REFERENCE NUMERALS

H Sound-absorbing enclosure
S Sound
E Sound emission source
D1, D2, D3 Characteristic lengths
M1, M2, M3 Centre points
K Cooling medium
B Component, roller bearing
C Neighboring component
G Housing
SL Airborne sound
SK Structure-borne sound
Z1-Z6 Random points
r Radial direction
u Circumferential direction
a Displacement value
R1 First edge of the enclosure
R2 Second edge of the enclosure
1,2,3 Hollow regions
4 Channel
9 Damping element

1. A method for producing a sound-absorbing enclosure (H) for a sound emission source (E) which emits sound (S) having an energy spectrum, wherein an irregular structure constructed from substructures is printed from a printing material by means of 3D printing, said structure having material regions which are formed by the printing material and which at least partly enclose hollow regions (1, 2, 3), wherein by virtue of the hollow regions (1, 2, 3) the substructures each have a characteristic length (D1, D2, D3) lying within a characteristic interval and each have a characteristic density, wherein the hollow regions (1, 2, 3) are specifically formed by appropriate guidance of the 3D printing process and thereby the substructures with these features are adapted to the energy spectrum in such a way that they dissipate sound (S) in a desired suppression range of the energy spectrum.

2. The method according to claim 1, wherein the structure is calculated by an algorithm.

3. The method according to claim 2, in which the algorithm is a random-based algorithm which generates the structure from a random distribution of the substructures with their predetermined characteristics within the enclosure (H).

4. The method according to claim 3, in which a geometry of the enclosure (H) is predetermined and a substructure of a hollow region (1,2,3) is generated by a random position of the center points (M1, M2, M3) and the diameter, which represent the characteristic length (D1, D2, D3), wherein the number of hollow regions (1,2,3) of a substructure thus generated is selected in accordance with a desired density of this substructure.

5. The method according to claim 2 in which hollow regions (1, 2, 3) are designed to overlap and are therefore open to one another in such a way that they form a continuous channel (4) through which a cooling liquid (K) or a cooling gas (K) can be guided.

6. The method according to claim 5, in which the continuous channel (4) is formed with statistically sufficient probability in a desired region in that the density of hollow regions (1, 2, 3) whose dimensions are suitable for channel formation is above a percolation threshold.

7. The method according to claim 2, in which the hollow regions (1, 2, 3) of a substructure are arranged offset from one another at an incommensurable distance (a) in a radial direction (r) as seen from the sound emission source (E) along a circumferential direction (u) with respect to the radial direction.

8. The method according to claim 1, in which at least some of the hollow regions (1, 2, 3) are designed in a geometric shape, whose orientation and characteristic lengths (D1, D2, D3) result in high sound dissipation according to the spatial distribution of the sound emitted by the sound emission source (E).

9. The method according to claim 8, in which the geometric shape is a half-screw shape and is designed such that an opening of the half-screw shape is oriented towards the sound emission source (E) and the screw flight converges in the direction of sound propagation.

10. A printed, sound-absorbing enclosure (H) for a sound emission source (E) which emits sound (S) having an energy spectrum, which has an irregular structure constructed of substructures, wherein the substructures each have a characteristic length scale (D1, D2, D3) and density and wherein the substructures are specifically formed by appropriate guidance of the 3D printing process and thereby adapted to the frequency spectrum in such a way that they dissipate sound (S) in a desired suppression range of the energy spectrum.

11. The enclosure (H) according to claim 10, wherein the composition of the structure of the substructures changes along an extension of the enclosure (H) in such a way that the sound (S) dissipating characteristics of the structure are adapted to an anisotropic emission of the sound emission source (E).

12. The enclosure (H) according to claim 10, in which at least some of the hollow regions (1, 2, 3) are connected to one another in a channel-like manner so that a cooling medium (K) can be guided through them.

13. The enclosure (H) according to claim 10, which is printed on a housing at least partly enclosing the sound emission source (E).

14. The enclosure (H) according to claim 10, which forms a housing (G) at least partly surrounding the sound emission source (E).

15. The enclosure (H) according to claim 10, in which the sound emission source (E) is positively connected to a connecting component (C), wherein the positive connection is formed by a damping element (9) produced using a 3D printing process in such a way that a structure-borne sound conduction from the sound emission source (E) to the connecting component (C) is weakened in a predetermined frequency range.

16. A roller bearing (B) comprising an enclosure (H) according to claim 10.

17. The roller bearing (B) according to claim 16, in which the enclosure (H) forms an outer ring with a raceway for rolling bodies.
